(19) United States
(12) Patent Application Publication
(10) Pub. No.: US 2015/0204726 A1
(43) Pub. Date: Jul. 23, 2015

(54) INFRARED DETECTION DEVICE AND INFRARED DETECTION METHOD

(71) Applicant: NEC Corporation, Minato-ku, Tokyo (JP)

(72) Inventors: Junichiro Mataga, Tokyo (JP); Yasuhiro Sasaki, Tokyo (JP); Masatake Takahashi, Tokyo (JP)

(73) Assignee: NEC Corporation, Minato-ku, Tokyo (JP)

(21) Appl. No.: 14/416,686

(22) PCT Filed: Mar. 4, 2013
(86) PCT No.: PCT/JP2013/055796

§ 371 Date: Jan. 23, 2015

(30) Foreign Application Priority Data
Jul. 25, 2012 (JP) 2012-165082

(51) Int. Cl. G01J 5/00; G01J 5/10

(52) U.S. Cl. CPC G01J 5/0025; G01J 5/10; G01J 2005/106

(57) ABSTRACT

An infrared detection device that can detect movement, a temperature, and a stationary state of a detection object with a simple configuration is provided.

The infrared detection device includes a pyroelectric infrared sensor (11), peak detecting means (12) for an electric signal waveform, peak inclination amount detecting means (13) for an electric signal waveform, peak value holding means (14) for an electrical signal waveform, and determining means (15), the sensor (11) outputs an electric signal depending on change in an infrared ray resulting from a detection object, the peak detecting means (12) detects a peak of a temporal waveform of an electric signal output by the sensor (11), the peak inclination amount detecting means (13) detects an inclination amount of a peak detected by the peak detecting means (12), the peak value holding means (14) holds an initial peak value when the detection object enters a detection region of the sensor (11), for a peak detected by the peak detecting means (12), and the determining means (15) determines entry of the detection object to and exit of the detection object from the detection region, a movement speed and a temperature of the detection object, and movement and motionlessness of the detection object in the detection region.

The present application is a National Stage Entry of PCT/JP2013/055796 filed Mar. 4, 2013, which is based on and claims the benefit of the priority of Japanese Patent Application No. 2012-165082, filed on Jul. 25, 2012, the disclosures of all of which are incorporated herein in their entirety by reference.

### TECHNICAL FIELD

The present invention relates to an infrared detection device and an infrared detection method.

### BACKGROUND ART

For the purpose of electric power saving, a temperature and a movement of a person in a building are detected by an infrared sensor to control lighting and air conditioning, for example. As an infrared sensor, there is a pyroelectric infrared sensor that is operable at a normal temperature. As a pyroelectric infrared sensor detecting a movement of a person, there is a sensor described in the patent literature 1, for example, and as a pyroelectric infrared sensor measuring a temperature distribution in a space, there is a sensor described in the patent literature 2.

### CITATION LIST

### Patent Literature

PTL 1: Patent Re-Publication No. WO2009/130959
PTL 2: Japanese Laid-open Patent Publication No. H5-1954

### SUMMARY OF INVENTION

### Technical Problem

In a conventional pyroelectric infrared sensor, surface charge generated by polarization change depending on temperature change (temperature difference) when a pyroelectric body receives an infrared ray is converted into voltage to output an electric signal. For this reason, in the conventional pyroelectric infrared sensor, an electric signal continues to be output for only a fixed period until the time when polarization change of the pyroelectric body disappears, and as a result, a temperature itself cannot be detected, for example. Accordingly, when a person remains stationary, and temperature change does not occur, the pyroelectric infrared sensor described in the patent literature 1 or the like cannot detect the stationary state of a person. To detect a state in which temperature change does not occur as in a case that a person remains stationary, it is necessary to make infrared rays intermittently incident into a sensor by a chopper mechanism as described in the patent literature 2, for example, which, however, makes a configuration of the sensor complicated.

Therefore, an object of the present invention is to provide an infrared detection device and an infrared detection method that can detect a movement and a temperature of a detection object such as a person, and can detect a stationary state of a detection object with a simple configuration.

### Solution to Problem

In order to accomplish the above-described object, an infrared detection device according to the present invention includes a pyroelectric infrared sensor, peak detecting means for an electric signal waveform, peak inclination amount detecting means for an electric signal waveform, peak value holding means for an electrical signal waveform, and determining means,

wherein the pyroelectric infrared sensor outputs an electric signal depending on change in an infrared ray resulting from a detection object,

the peak detecting means detects a peak of a temporal waveform of an electric signal output by the sensor,

the peak inclination amount detecting means detects an inclination amount of a peak detected by the peak detecting means,

the peak value holding means holds an initial peak value when the detection object enters a detection region of the sensor, for a peak detected by the peak detecting means, and

the determining means

determines at least one of entry of the detection object to and exit of the detection object from the region of the sensor, based on the detected peak,

determines at least one of a movement speed and a temperature of the detection object, based on the peak inclination amount, and

determines at least one of movement and motionlessness of a detection object in the detection region of the sensor, based on whether or not the held peak value is held for a waveform saturation period acquired from an inclination amount of the initial peak.

An infrared detection method according to the present invention includes:

a peak detecting step of detecting a peak of a temporal waveform of an electric signal that is output by a pyroelectric infrared sensor and that depends on change in an infrared ray resulting from a detection object;

an inclination amount detecting step of detecting an inclination amount of a peak detected at the peak detecting step;

a peak value holding step of holding an initial peak value when the detection object enters a detection region of the sensor, for a peak detected at the peak detecting step; and

a determining step of

determining at least one of entry of the detection object to and exit of the detection object from the region of the sensor, based on the detected peak,

determining at least one of a movement speed and a temperature of the detection object, based on the peak inclination amount, and

determining at least one of movement and motionlessness of the detection object in the detection region of the sensor, based on whether or not the held peak value is held for a waveform saturation period acquired from an inclination amount of the initial peak.

### Advantageous Effects of Invention

According to the present invention, movement and a temperature of a detection object such as a person can be detected, and a stationary state of the detection object can be detected with a simple device configuration.

### BRIEF DESCRIPTION OF DRAWINGS

FIG. 1A is a configuration diagram illustrating one example of an infrared detection device according to the present invention, and FIG. 1B is a configuration diagram illustrating another example of an infrared detection device according to the present invention.

FIG. 2A is an exploded perspective view illustrating one example of a configuration of a pyroelectric infrared sensor, and FIG. 2B is a sectional view seen in the I-I direction in FIG. 2A.

FIG. 3 is a flowchart illustrating one example of a flow of processing by the infrared detection device according to the present invention.

FIG. 4 is a graph illustrating one example of a waveform of an electric signal of the pyroelectric infrared sensor.

FIG. 5A is an explanatory diagram describing one example of detection of a detection object in the infrared detection device according to the present invention, and FIG. 5B is a graph illustrating one example of an output waveform of the sensor accompanying movement of the detection object.

FIG. 6A is a graph illustrating one example of an output waveform of the pyroelectric infrared sensor, and FIG. 6B is a graph illustrating one example of a state in which a peak value in the output waveform is held.

### DESCRIPTION OF EMBODIMENTS

In the infrared detection device according to the present invention, it is preferable that the pyroelectric infrared sensor is an array type sensor in which a plurality of pyroelectric infrared detection elements are arranged in an array on a substrate.

In the present invention, it is preferable to detect a one-dimensional or two-dimensional temperature distribution.

A person movement detection device according to the present invention includes the infrared detection device according to the present invention, the detection object is a person, and the pyroelectric infrared sensor detects infrared rays from the person to detect movement of the person.

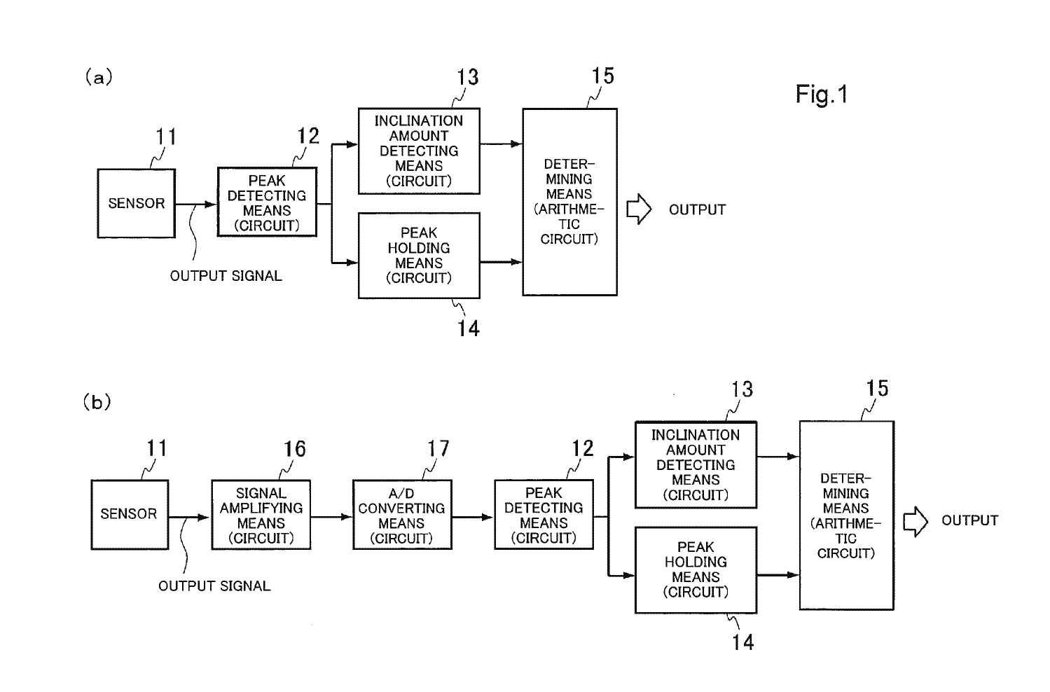

Next, the present invention is described by citing examples. However, the present invention is not limited and restricted by the below description. In FIGS. 1 through 6, the same reference symbols are attached to the same parts.

FIG. 1A illustrates a configuration of an infrared detection device according to the present embodiment. As illustrated in the drawing, the infrared detection device according to the present embodiment includes a pyroelectric infrared sensor 11, peak detecting means (circuit) 12, peak inclination amount detecting means (circuit) 13, peak value holding means (peak holding means (circuit)) 14, and determining means (arithmetic circuit) 15. In the infrared detection device according to the present embodiment, an electric signal of the sensor 11 is first sent to the peak detecting means (circuit) 12, a peak inclination amount is detected by the peak inclination amount detecting means (circuit) 13 concerning a peak detected by the peak detecting means (circuit) 12, and an initial peak value when the detection object enters a detection region of the sensor is held by the peak value holding means (peak holding means (circuit)) 14. The determining means (arithmetic circuit) 15 determines at least one of entry of the detection object to and exit of the detection object from the region of the sensor, based on the detected peak, determines at least one of a movement speed and a temperature of the detection object based on the detected peak inclination amount, and determines at least one of movement and motionlessness of the detection object in the detection region of the sensor, based on whether or not the held peak value is held for a waveform saturation period acquired from an inclination amount of the initial peak.

As illustrated in FIG. 1B, in the infrared detection device according to the present invention, it is preferable to include signal amplifying means (circuit) 16 and analog/digital (A/D) converting means (circuit) 17. As illustrated in this drawing, in the device according to the present embodiment, an analog electric signal output from the sensor is amplified by the signal amplifying means (circuit) 16, the amplified analog signal is converted into a digital signal by the A/D converting means (circuit) 17, and the converted digital signal is sent to the peak detecting means (circuit) 12. Following after that is the same as in the device illustrated in FIG. 1A.

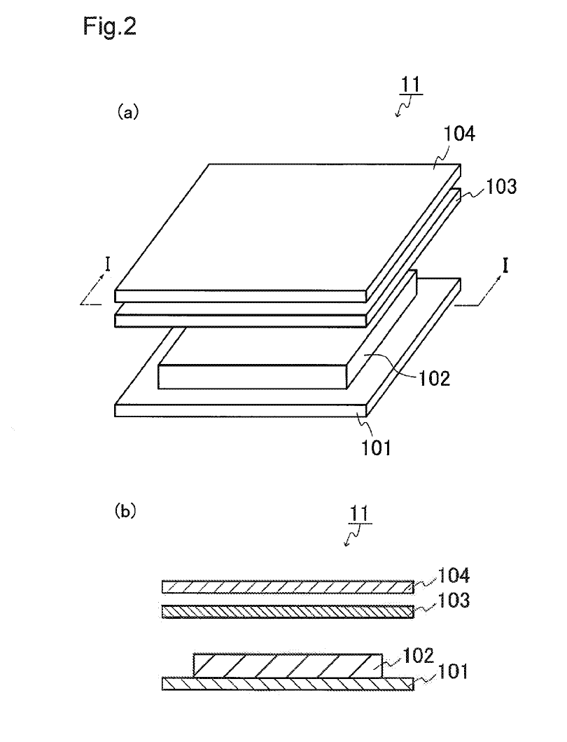

One example of a configuration of the pyroelectric infrared sensor 11 is illustrated in FIG. 2. FIG. 2A is an exploded perspective view of the sensor, and FIG. 2B is a sectional view seen in the I-I direction in FIG. 2A. As illustrated in FIG. 2, the sensor of the present example is configured by arranging an infrared detection element 102 on a substrate 101, arranging an optical filter 103 on the infrared detection element 102, and arranging an optical diffraction lens 104 on the optical filter 103. The substrate 101 is a silicon substrate and a glass substrate, for example. The infrared detection element 102 is pyroelectric ceramics or a single crystal, having pyroelectric effect, for example. For example, the infrared detection element 102 is formed or arranged on the substrate 101 by a film forming process, attachment, or the like to be integrally joined therewith, and is wrapped (packaged) after electrodes and wiring for electrical connection are formed. The optical filter 103 is an infrared filter that transmits only an infrared ray, for example. The optical diffraction lens 104 is a Fresnel lens, for example, and use of a Fresnel lens makes it possible to secure a wide viewing angle. As described above, in the pyroelectric infrared sensor, surface charge is generated in a pyroelectric body by temperature difference due to change of an infrared ray, and this surface charge is converted into a voltage signal to be output. Accordingly, in the pyroelectric infrared sensor, even when there is an incidence of an infrared ray, if the incidence of the infrared ray does not change, an electric signal is not output.

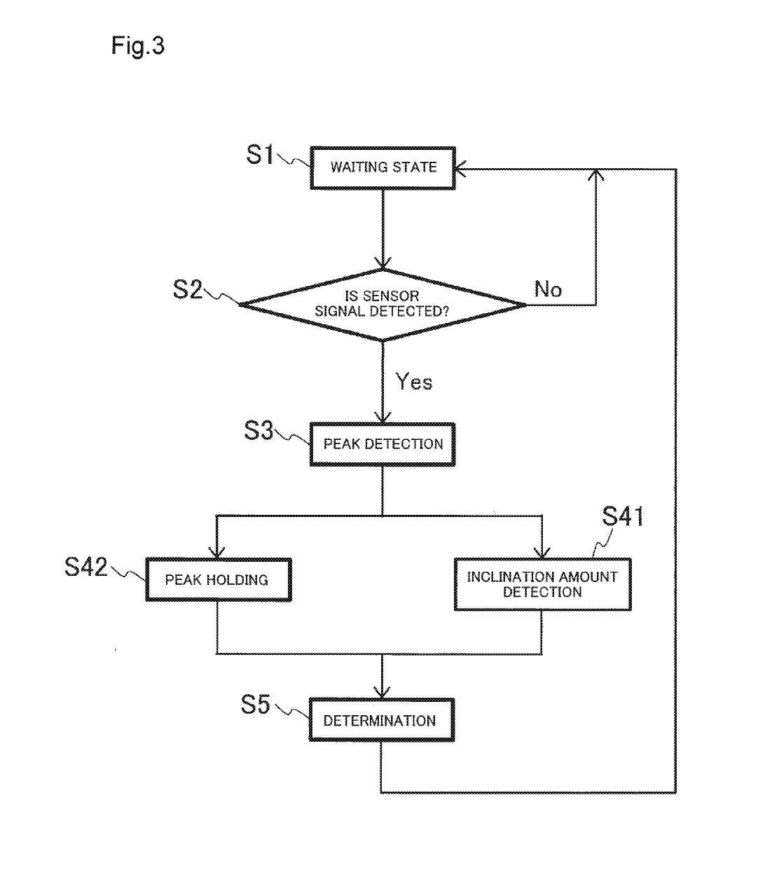

A flowchart of FIG. 3 illustrates processing by the infrared detection device according to the present embodiment. First, from a waiting state (S1), it is determined whether or not a signal from the sensor is detected (S2). When a signal is not detected (No), the process returns to the waiting state (S1) again, and when a signal is detected (Yes), detection of a peak is performed by the peak detecting means (S3). Then, for the detected peak, an inclination amount is detected (S41), and holding (peak holding) of a peak value when a detection object enters a detection region of the sensor for the first time is performed (S42). Then, based on holding of the detected peak, the peak inclination amount, and the peak value, the determining means determines at least one of entry of the detection object to and exit of the detection object from the detection region of the sensor, at least one of a movement speed and a temperature of the detection object, and at least one of motionlessness and movement of the detection object, respectively (S5). The determination results are output to a display or the like, and the process returns to the waiting state again (S1). Details of the determination based on a waveform of an electric signal will be described later.

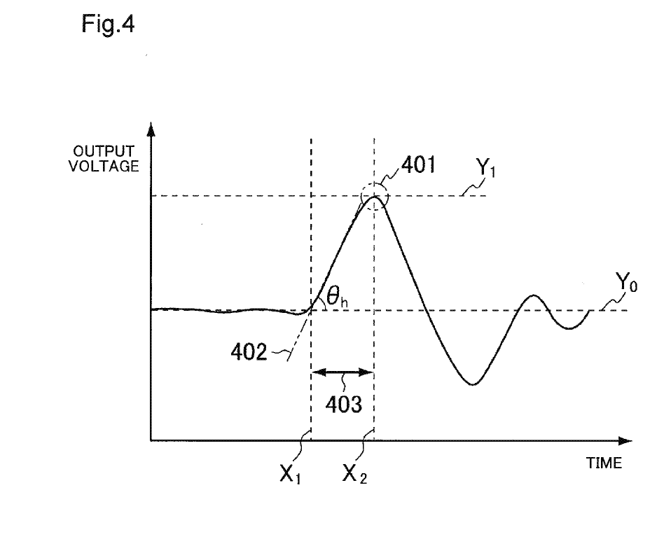

A graph of FIG. 4 illustrates one example of a waveform of output of the pyroelectric infrared sensor. In the graph of FIG. 4, the horizontal axis indicates time, and the vertical axis indicates sensor output voltage. Further, in the graph of FIG. 4, Y₀ indicates voltage when there is no change in an infrared ray, Y₁ indicates voltage of a peak when there is output, X₁ indicates output start time, and X₂ indicates time of the peak of the output. The infrared detection device according to the present embodiment includes a function of holding a peak value 401 of an output voltage waveform when the sensor detects a detection object, and a function of detecting an inclination amount 402 (an angle θₕ in the drawing) of a peak. In the graph of FIG. 4, a period 403 to the time when a sensor output value reaches the peak is a characteristic value determined by the pyroelectric infrared sensor. Accordingly, an energy amount of infrared rays incident on the sensor can be acquired from the inclination amount 402. For this reason, from an inclination amount of output voltage accompanying movement of the detection object, it is possible to detect whether a temperature is high or low and whether a movement speed is high or low. Since output differs by a temperature and a distance, when a distance is constant, the movement speed can be quantitatively detected like A kilometers per hour, for example, by comparing an inclination amount of output voltage caused by a movement speed of the detection object having a certain temperature with a calibration value. When a movement speed and a distance are constant, the temperature can be quantitatively detected like B ° C., for example, from a peak value of an output voltage waveform generated by temperature change accompanying movement of the detection object, by comparison with a calibration value. While the inclination amount 402 of the peak is represented by an angle θₕ in FIG. 4, the present invention is not limited thereto, and an inclination amount of a peak may be a differential value, for example. The inclination amount 402 of the peak is detected as inclination of a tangential line of rising of the output waveform, or inclination of a straight line connecting a rising start point and the peak value. A period to the time when an output waveform of the pyroelectric infrared sensor is saturated is determined by an inclination amount (incident energy amount). For this reason, based on saturation of an output waveform, it can be determined whether the detection object becomes stationary in a detection range, or passes through the detection range. Details of determination of a stationary state will be described later.

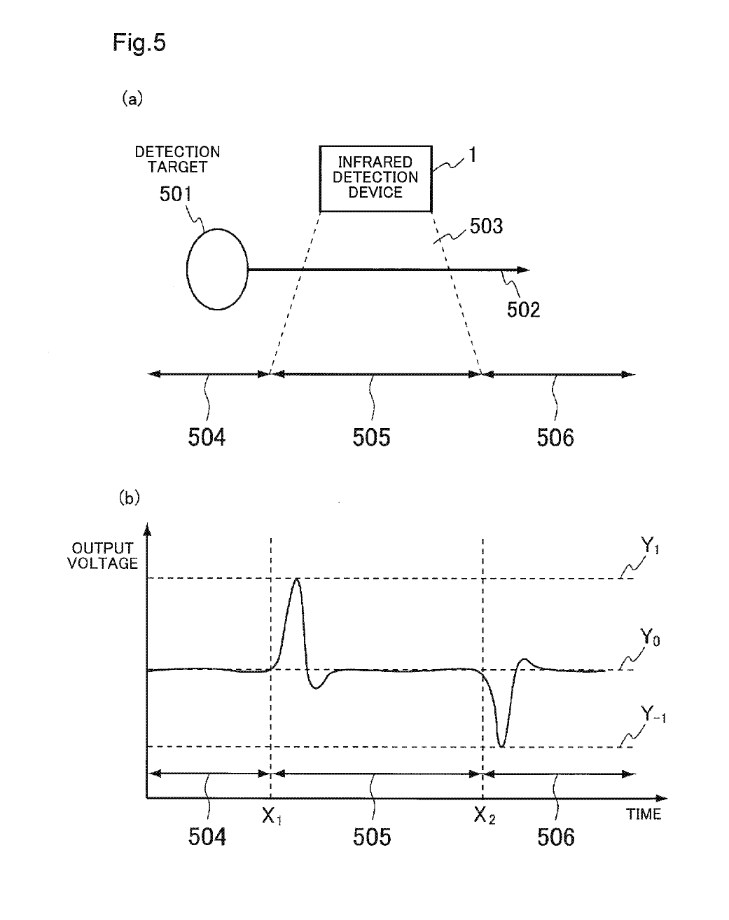

Next, based on FIG. 5, description is made about relation between movement of the detection object and a waveform of an electric signal output by the sensor in a period between entry of the detection object to and exit of the detection object from the detection region. In FIG. 5A, 501 indicates the detection object, an arrow of 502 indicates a movement direction of the detection object 501, and 503 indicates the detection region of the sensor. In a graph of FIG. 5B, the horizontal axis represents time, the vertical axis represents output voltage of the sensor, X₁ indicates the time when the detection object 501 enters the detection region 503, X₂ indicates the time when the detection object 501 exits the detection region 503, Y₀ indicates output voltage of the sensor when there is no change in an infrared ray, Y₁ indicates output voltage of an initial peak when the detection object 501 enters the detection region 503, and Y-₁ indicates output voltage of a peak when the detection object 501 exits the detection region 503. In both of FIGS. 5(a) and (b), 504 indicates a period before the detection object 501 enters the detection region 503, 505 indicates a period when the detection object 501 exists in the detection region 503, and 506 indicates a period after the detection object 501 exits the detection region 503.

When the detection object 501 is positioned outside the detection region (range) 503 of the infrared detection device according to the present embodiment (504), a signal is not output. When the detection object 501 moves into the detection region 503, the infrared detection device according to the present embodiment generates output voltage depending on temperature difference between the detection object 501 and the surrounding. Based on a peak of output at this time, entry of the detection object 501 to the detection region 503 is determined, and this peak value is held. At this time, when the detection object 501 stops moving in the detection region 503, time lapse causes polarization change to disappear so that sensor output is not obtained in a case of a conventional sensor, and a state returns to the same equilibrium state as at the time when being positioned outside the detection region. However, according to the present invention, during a period when the detection object 501 remains stationary in the detection region 503, the peak value is held so that the existence in the detection region can continue to be detected, until the detection object performs a next operation, based on holding of the peak for saturation time acquired from a peak inclination amount. When a peak value of the sensor output attenuates before elapse of the saturation time, this means that the detection object 501 passes through the detection region 503 without stopping movement in the detection region 503. Next, when the detection object 501 exits the detection region 503, the sensor generates output that depends on temperature difference between a temperature of the detection object 501 and a surrounding temperature and of which direction is opposite to the direction of the entry, and a peak thereof is detected so that exit of the detection object 501 from the detection region 503 is determined. Thus, according to the present invention, based on a peak, entry of the detection object to or exit of the detection object from the detection region can be determined, a stationary state in the detection region can be also determined, and further, determination of a stationary state does not need a special device such as a chopper mechanism. A method of determining a stationary state is as follows. When the detection object 501 enters the detection region 503, a sensor output waveform is generated with a peak inclination amount which is characteristic of the sensor. At the time of the exit, the same occurs, but the sensor output waveform behaves inversely. When the detection object 501 stops moving in the detection region 503, only entry is detected. Since a peak value of an output waveform at the time of entry continues to be held until a peak of an output waveform at the time of exit is detected, a stationary state can be determined.

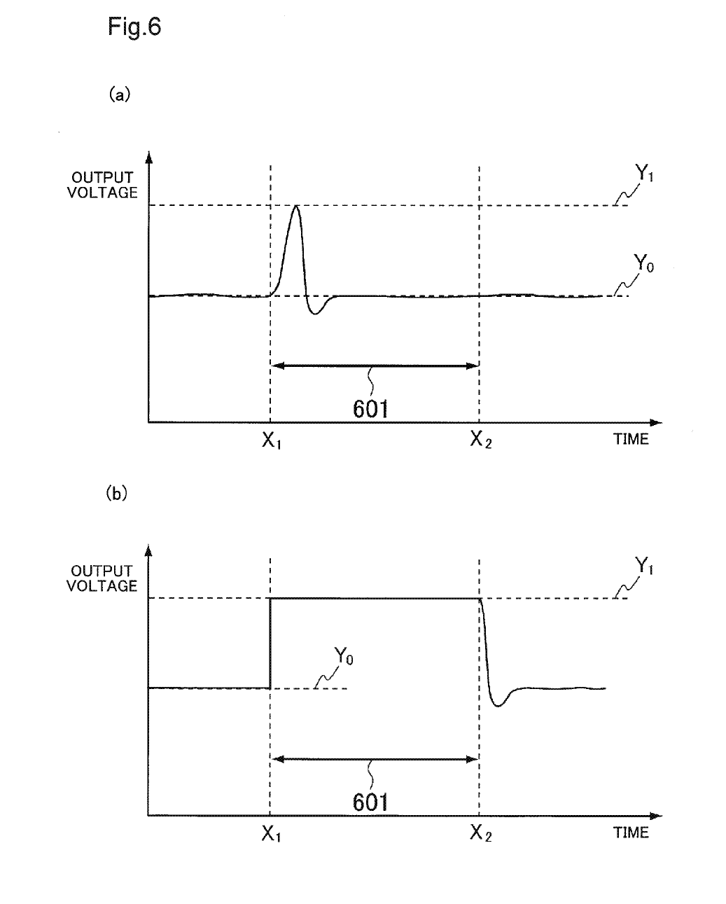

FIG. 6A illustrates a graph of an output waveform of the sensor, and FIG. 6B illustrates a graph when a peak value of the output waveform is held. In both of FIGS. 6A and B, the horizontal axis represents time, the vertical axis represents output voltage, X₁ indicates time when the detection object 501 enters the detection region 503, X₂ indicates time when the waveform is saturated, 601 indicates a period until the waveform is saturated, Y₀ indicates output voltage of the sensor when there is no change in an infrared ray, and Y₁ indicates output voltage at an initial peak when the detection object 501 enters the detection region 503. The pyroelectric infrared sensor outputs a sensor signal depending on temperature difference between the surrounding and the detection object, and an output waveform of an output signal of the sensor is inverted in accordance with a positive and a negative of the temperature difference. For this reason, from inversion of the temperature difference, entry of the detection object to and exit of the detection object from the detection region of the sensor can be distinguished from each other, and thereby, in the present invention, a state in which the detection object exists in the detection region can be detected by holding an initial peak value at the time when the detection object enters the detection region of the sensor.

Next, embodied examples of the present invention are described.

### Example 1

Electrode layers having a thickness of 5 μm were formed on upper and lower main surfaces of square pyroelectric ceramics (10 mm long×10 mm wide×90 μm thick) to produce an infrared detection element.

This infrared detection element is arranged on an MgO substrate (10 mm long×10 mm wide×100 μm thick), and an infrared filter (Si filter) was arranged on the infrared detection element to produce a pyroelectric infrared sensor.

By using the pyroelectric infrared sensor, change in infrared rays of below-described detection object whose movement speeds are different was detected, and inclination amounts (normalized values) of initial peaks at the time of entry to the detection region of the sensor were detected. The results are shown in the below table 1. Note that the term “normalized values” represents relative ratios of detection object 2 and 3 when an inclination amount of a peak of a detection object 1 is a reference (1).

A detection object 1: A human body (detection object) having a temperature of 36.5° C. enters the detection region of the sensor at a speed of 3 kilometers per hour.
A detection object 2: The detection object enters the detection region of the sensor at a speed of 5 kilometers per hour.
A detection object 3: The detection object enters the detection region of the sensor at a speed of 7 kilometers per hour.

TABLE 1

| | DETEC- | DETEC- | DETEC- |
|---|---|---|---|
| | TION OB- | TION OB- | TION OB- |
| | JECT 1 | JECT 2 | JECT 3 |
| NORMALIZED VALUE OF | 1 | 5 | 10 |
| INCLINATION AMOUNT | | | |
| OF OUTPUT VOLTAGE | | | |

As seen from the table 1, an inclination amount of a peak increased in accordance with a movement speed. From this result, it can be said that a movement speed of the detection object can be determined in the present invention.

### Example 2

By using the same pyroelectric infrared sensor as in the example 1, change in infrared rays of below-described detection object having different temperatures was detected, and inclination amounts (normalized values) of initial peaks at the time of entry to the detection region of the sensor were detected. The result is shown in the below table 2.

A detection object 1: A human body (detection object) having a temperature of 35.0° C. enters the detection region of the sensor at a speed of 5 kilometers per hour.
A detection object 2: A human body (detection object) having a temperature of 36.0° C. enters the detection region of the sensor at the same speed as the above.
A detection object 3: A human body (detection object) having a temperature of 36.5° C. enters the detection region of the sensor at the same speed as the above.

TABLE 2

| | DETEC- | DETEC- | DETEC- |
|---|---|---|---|
| | TION OB- | TION OB- | TION OB- |
| | JECT 1 | JECT 2 | JECT 3 |
| NORMALIZED VALUE OF | 1 | 3 | 5 |
| INCLINATION AMOUNT | | | |
| OF OUTPUT VOLTAGE | | | |

As seen from the table 2, an inclination amount of a peak increased in accordance with a temperature. From this result, it can be said that a temperature of the detection object can be determined in the present invention.

### Example 3

By using the same pyroelectric infrared sensor as in the example 1, a series of movements was detected, in which a human body (detection object) of 36.5° C. enters the detection region of the sensor at a speed of 3 kilometers per hour, remains stationary in the detection region for 5 seconds, and then, exits the detection region of the sensor at a speed of 3 kilometers per hour. Specifically, an initial peak value in a waveform of the sensor when the detection object enters the detection region of the sensor was held for a waveform saturation time. The result is shown in the below table 3.

TABLE 3

| TIME(SECOND) | 0 | 1 | 2, . . . , 7 | 8 | 9 | 10 |
|---|---|---|---|---|---|---|
| NORMALIZED VALUE OF | 0 | 5 | 5 | −5 | 0 | 0 |
| OUTPUT VOLTAGE PEAK | | | | | | |

As shown in the table 3, at a detection start point (0 second), a peak was not detected, but an initial peak was observed at the time when 1 second elapses from the detection of start so that entry of the detection object to the detection region of the sensor could be detected. Then, the peak value was held from 2 to 7 seconds from the detection of start, and as a result, it could be determined that the detection object remains in a stationary state. Then, 8 seconds later from the detection of start, an inversed peak was detected so that exit of the detection object from the detection region of the sensor could be determined. As seen from the present embodied example, according to the present invention, by holding an initial peak value at the time of entry of the detection object to the detection region of the sensor, a stationary state of the detection object could be detected.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2012-165082, filed on Jul. 25, 2012, the disclosure of which is incorporated herein in its entirety by reference.

### REFERENCE SIGNS LIST

11 Pyroelectric infrared sensor, 12 Peak detecting means, 13 Peak inclination amount detecting means, 14 Peak value holding means, 15 Determining means, 16 Signal amplifying means, 17 A/D converting means, 101 Substrate, 102 Infrared detection element (pyroelectric body), 103 Optical filter, 104 Optical diffraction lens, 401 Peak, 402 Inclination amount, 403 Time, 501 Detection object, 502 Movement direction, 503 Detection region of a sensor, 504 Time, 505 Time, 506 Time, 601 Time

What is claimed is:

1. An infrared detection device comprising a pyroelectric infrared sensor, peak detecting unit for an electric signal waveform, peak inclination amount detecting unit for an electric signal waveform, peak value holding unit for an electrical signal waveform, and determining unit,
wherein the pyroelectric infrared sensor outputs an electric signal depending on change in an infrared ray resulting from a detection object,
the peak detecting unit detects a peak of a temporal waveform of an electric signal output by the sensor,
the peak inclination amount detecting unit detects an inclination amount of a peak detected by the peak detecting unit,
the peak value holding unit holds an initial peak value when the detection object enters a detection region of the sensor, for a peak detected by the peak detecting unit, and
the determining unit
determines at least one of entry of the detection object to and exit of the detection object from the sensor region based on the detected peak,
determines at least one of a movement speed and a temperature of the detection object, based on the peak inclination amount, and
determines at least one of movement and motionlessness of a detection object in a detection region of the sensor, based on whether or not the held peak value is held for a waveform saturation period acquired from an inclination amount of the initial peak.

2. The infrared detection device according to claim 1, wherein the pyroelectric infrared sensor is an array type sensor in which a plurality of pyroelectric infrared detection elements are arranged in an array on a substrate.

3. The infrared detection device according to claim 1, detecting a one-dimensional or two-dimensional temperature distribution.

4. A person movement detection device comprising the infrared detection device according to claim 1,
wherein the detection object is a person, and the pyroelectric infrared sensor detects an infrared ray from the person to detect movement of the person.

5. An infrared detection method comprising:
detecting a peak of a temporal waveform of an electric signal that is output by a pyroelectric infrared sensor and that depends on change in an infrared ray resulting from a detection object;
detecting an inclination amount of a peak detected;
holding an initial peak value when the detection object enters a detection region of the sensor, for a peak detected;
determining at least one of entry of the detection object to and exit of the detection object from the sensor region based on the detected peak;
determining at least one of a movement speed and a temperature of the detection object, based on the peak inclination amount; and
determining at least one of movement and motionlessness of a detection object in a detection region of the sensor, based on whether or not the held peak value is held for a waveform saturation period acquired from an inclination amount of the initial peak.

6. An infrared detection device comprising a pyroelectric infrared sensor, peak detecting means for an electric signal waveform, peak inclination amount detecting means for an electric signal waveform, peak value holding means for an electrical signal waveform, and determining means,
wherein the pyroelectric infrared sensor outputs an electric signal depending on change in an infrared ray resulting from a detection object,
the peak detecting means detects a peak of a temporal waveform of an electric signal output by the sensor,
the peak inclination amount detecting means detects an inclination amount of a peak detected by the peak detecting means,
the peak value holding means holds an initial peak value when the detection object enters a detection region of the sensor, for a peak detected by the peak detecting means, and
the determining means
determines at least one of entry of the detection object to and exit of the detection object from the sensor region based on the detected peak,
determines at least one of a movement speed and a temperature of the detection object, based on the peak inclination amount, and
determines at least one of movement and motionlessness of a detection object in a detection region of the sensor, based on whether or not the held peak value is held for a waveform saturation period acquired from an inclination amount of the initial peak.
